(19) United States
(12) Patent Application Publication
(10) Pub. No.: US 2023/0130005 A1
(43) Pub. Date: Apr. 27, 2023

(54) OPTICAL SHOOTING ACCURACY INDICATION SYSTEM

(71) Applicant: SMART DETECTION INITIATIVES LTD., Yonatan (IL)

(72) Inventor: Noach Itzhak Rabinovich, Yonatan (IL)

(21) Appl. No.: 17/798,696

(22) PCT Filed: Feb. 14, 2021
(86) PCT No.: PCT/IL2021/050173

§ 371 Date: Aug. 10, 2022

(30) Foreign Application Priority Data
Feb. 16, 2020 (IL) 272704

(51) Int. Cl. F41J 5/02; F41J 5/14; G01V 8/20

(52) U.S. Cl. CPC F41J 5/02; F41J 5/14; G01V 8/20

(57) ABSTRACT

An optical shooting accuracy indication system, comprising apparatus for generating a single-layer optical screen with alternatingly switching first and second light sources; a control apparatus for distinguishing between the light that is emitted by said first and second light sources during different first and second time domains, respectively, and for identifying an impingement region of a fired projectile through the generated optical screen.

### FIELD OF THE INVENTION

The present invention relates to the field of target systems. More particularly, the invention relates to an optical shooting accuracy indication system.

### BACKGROUND OF THE INVENTION

Various optical shooting accuracy indication systems are known in the prior art to avoid the inconvenience and inefficient time utilization of having to physically approach a target and to measure the distance between a predetermined target and the position of a projectile's impact point.

In a first approach shown in FIG. 1, a plurality of spaced light emitters located at a known position are mounted in first and second adjacent sides of a rectangular frame, and a plurality of light receivers are mounted in third and fourth sides of the frame at an opposite side from the first and second sides, respectively, such that each light receiver receives the light beam emitted from a corresponding light emitter. The passage of a projectile through the frame temporarily interrupts at least one light beam emitted from each of the first and second sides, and the region of the frame, as defined by XY emitter-location coordinates, through which the projectile passed based on which light beams were interrupted can be determined. However, this system is costly due to the large number of light emitters that are needed and is also energy intensive since all light emitters have to be constantly operated in order to accurately determine which light beams were interrupted by the projectile.

In a second approach as shown in FIG. 2, two light emitters 1 each generating a wide-angle beam 12 or 13, e.g. a 90-degree beam, are mounted at a corresponding corner of the rectangular frame 5, in order to completely illuminate the interior 4 of the frame and to reduce the number of light emitters that are needed. A U-shaped array of light receivers 3 is deployed at three sides 17-19 of the rectangular frame 5, such that each of the receivers 3 normally always receives the emitted light. When a projectile 10 is fired through the frame interior 4, the projectile interrupts a portion of beams 12 and 13 and produces a shadowing effect whereby regions of the U-shaped array do not receive the emitted light due to the temporary interruption caused by the passage of projectile 10 through frame interior 4. In the illustrated example of FIG. 2, a shadowed region H is produced at side 19 of the light receiver array by the interruption of beam 12 and a shadowed region W is produced at side 18 of the light receiver array by the interruption of beam 13. By knowing the location of shadowed regions H and W, the impingement region of projectile 10 with respect to frame interior 4 may be determined by the intersection of each line extended from the center of a shadowed region to the center of the corresponding light emitter.

A major problem with conventional methods is lack of shadowing. As shown in FIG. 2, without separating the light curtains, the system of FIG. 2 is incapable of distinguishing between two distinct shadowed regions produced by the interruption of beams 12 and 13, respectively. When the two light sources illuminate at the same time, one light source eliminates the shadow that is created by the other light source, and vice versa. This leads to a situation where shadowing will not be possible.

FIG. 3 shows another problem, at times the system of FIG. 2 is incapable of distinguishing between two distinct shadowed regions produced by the interruption of beams 12 and 13, respectively, when projectile 10 impinges frame interior 4 relatively close to one of the sides of frame 5. When frame interior 4 is impinged by projectile 10, which has a length P, relatively close to one of the sides of frame 5, the two shadowed regions that are produced at side 18 of the light receiver array by the interruption of beams 12 and 13, respectively, completely overlap at overlapped shadowed region O having a length greater than P. Since overlapped shadowed region O has a length greater than P, the exact impingement region of projectile 10 cannot be determined due to the uncertainty as to which shadowed region is associated with beam 12 and which shadowed region is associated with beam 13.

Another problem is the accuracy of the light sources. Low accuracy can cause light from one light source to leak toward sensors which it should not illuminate. On the other hand, accurate light sources are expensive.

CN101294784 discloses a two-layered light curtain to solve the problem of the indistinguishability of shadowed regions in an optical shooting accuracy indication system. The two-layered light curtain is characterized by two spaced U-shaped arrays of light receivers arranged such that each of the two light emitters mounted at a corresponding corner of the rectangular frame generates a wide-angle beam that is directed to only one of the U-shaped arrays. Thus a first array will receive only the light emitted by a first light emitter, and a second array will receive only the light emitted by a second light emitter. When the frame interior is impinged by a projectile, the two shadowed regions that are produced by the interruption of the two beams, respectively, will be distinguishable. That is, the first shadowed region will be detected by the first array of light receivers, and the second shadowed region will be detected by the second array of light receivers. However, this configuration is costly due to the need of two separate arrays of light receivers.

It is an object of the present invention to provide a cost effective optical shooting accuracy indication system that is able to distinguish between two shadowed regions that are produced by the interruption of the two wide-angle beams, respectively, in response to the impingement of the interior of a rectangular frame by a projectile.

It is another object of the present invention to provide a cost effective optical shooting accuracy indication system that saves energy and does not require expensive hardware.

Other objects and advantages of the invention will become apparent as the description proceeds.

### SUMMARY OF THE INVENTION

An optical shooting accuracy indication system, comprising apparatus for generating a single-layer optical screen with alternatingly switching first and second light sources; and control apparatus for distinguishing between light that is emitted by said first and second light sources during different first and second time domains, respectively, and for identifying an impingement region of a fired projectile through said generated optical screen.

In one aspect, the single-layer optical screen generating apparatus comprises a rectangular frame having an unobstructed interior that is delimited by four frame sides, the first light source which is mounted at a first corner of said frame and emits a beam of light that is directed to said frame interior, the second light source which is mounted at a second corner of said frame and emits a beam of light that is directed to said frame interior, and a single U-shaped array of light receivers which is deployed at three sides of said frame, such that all of said receivers are configured to simultaneously receive the light emitted by the first light source or by the second light source at any given time prior to impingement of a fired projectile through the generated optical screen, wherein one or more regions of the light receivers are exposed to a shadowing effect due to a temporary interruption of a portion of the two beams emitted by the first and second light sources, respectively, caused by passage of the fired projectile through the frame interior.

In one aspect, the control apparatus comprises an analysis module, and a data bus in data communication with each of the light receivers which are installed at a corresponding side of the frame and with said analysis module, said data bus providing to said analysis module an address for each of the light receivers installed at the corresponding side of the frame and a discrete data indicator as to whether a given receiver is presently receiving light emitted by one of the first and second light sources or is subjected to a shadowing effect.

In one aspect, the analysis module is operable to receive and analyze a receiver-specific light-receiving data indicator from each of the light receivers and to determine the impingement region of the projectile with respect to the frame interior depending on which of the light receivers has been subjected to a shadowing effect.

In one aspect, the control apparatus further comprises a two-channeled driver configured to alternately and cyclically switch activation power supplied to each of the first and second light sources.

In one aspect, the control apparatus further comprises control circuitry responsive to a switching software module which is configured to generate a switching binary input to each of the two channels of the driver, such that the binary input to each of the two channels is different at any given instant.

In one aspect, the system further comprises communication apparatus in data communication with the analysis module and a computerized device in data communication with the communication apparatus, wherein the communication apparatus is operable to transmit to the computerized device a signal containing data which is representative of the determined impingement region of the projectile with respect to the frame interior.

In one aspect, the computerized device is a handheld mobile device which is configured with an application running on a processor of the mobile device, wherein the mobile device is operable to display the impingement region of the projectile relative to a target immediately after a shooting operation.

### BRIEF DESCRIPTION OF THE DRAWINGS

In the drawings:

FIG. 1 (prior art) shows a first approach with a plurality of spaced light emitters located at a known position are mounted in first and second adjacent sides of a rectangular frame, and a plurality of light receivers are mounted in third and fourth sides of the frame at an opposite side from the first and second sides, respectively;

FIG. 2 is a front view of a rectangular frame equipped with two light emitters and a U-shaped array of light receivers, schematically illustrating the production of two separate shadowed regions by a fired projectile that interrupts the generated beams;

FIG. 3 is a schematic illustration of the frame of FIG. 2, showing an uncertainty producing overlapped shadowed region resulting from the impingement of the frame interior by a projectile relatively close to one of the sides of the frame;

FIG. 4 is a schematic illustration of an embodiment of an optical shooting accuracy indication system;

FIG. 5 is a front view of a frame used in conjunction with the system of FIG. 4, schematically illustrating a method for determining an impingement region of a projectile with respect to the frame interior;

FIG. 6 is a front perspective view of a frame used in conjunction with the system of FIG. 4, showing support elements by which it is mounted;

FIG. 7 is a front perspective view of a handheld mobile device that displays an impingement region of a projectile relative to a target immediately after a shooting operation; and

FIG. 8 is a schematic illustration of a typical waveform generated by the control circuitry of FIG. 4 for transmission to one channel of the driver.

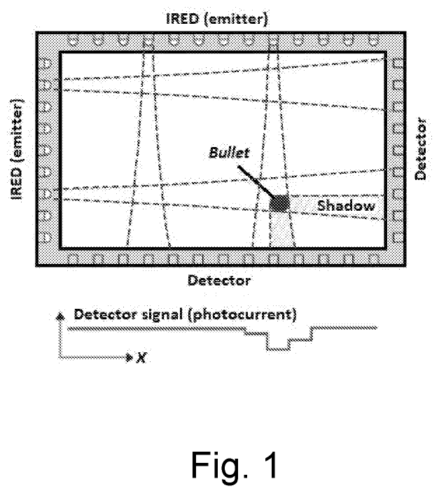

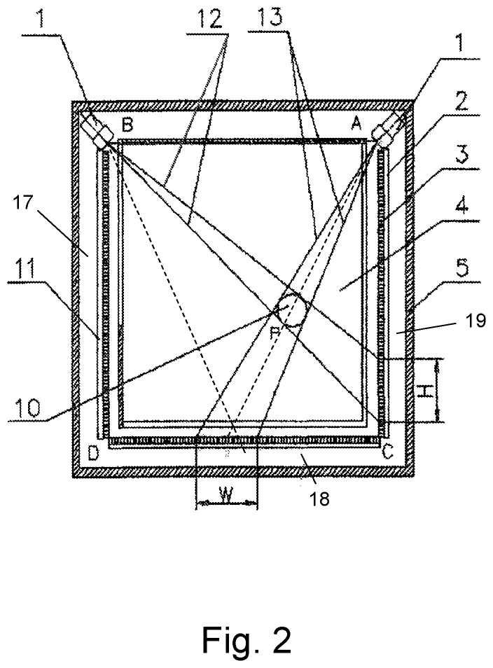

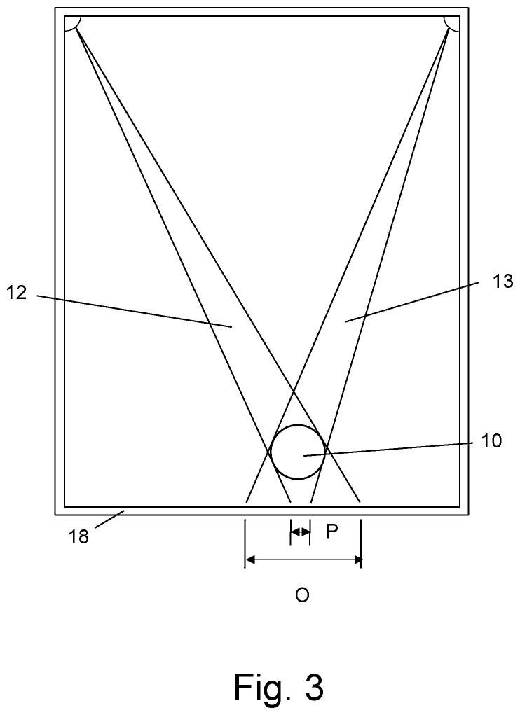

### DETAILED DESCRIPTION OF THE INVENTION

In the optical shooting accuracy indication system of the present invention, a single layer of light receivers arranged as a U-shaped array is employed, yet an accurate determination of the impingement point of the projectile through the optical screen is able to be obtained despite being subject to a completely overlapping shadowing effect by means of light emitted in two distinct time domains. A first shadowed region is able to be detected by light generated in the first time domain, and a second shadowed region is able to be detected by light generated in the second time domain and distinguished from the light generated in the first time domain.

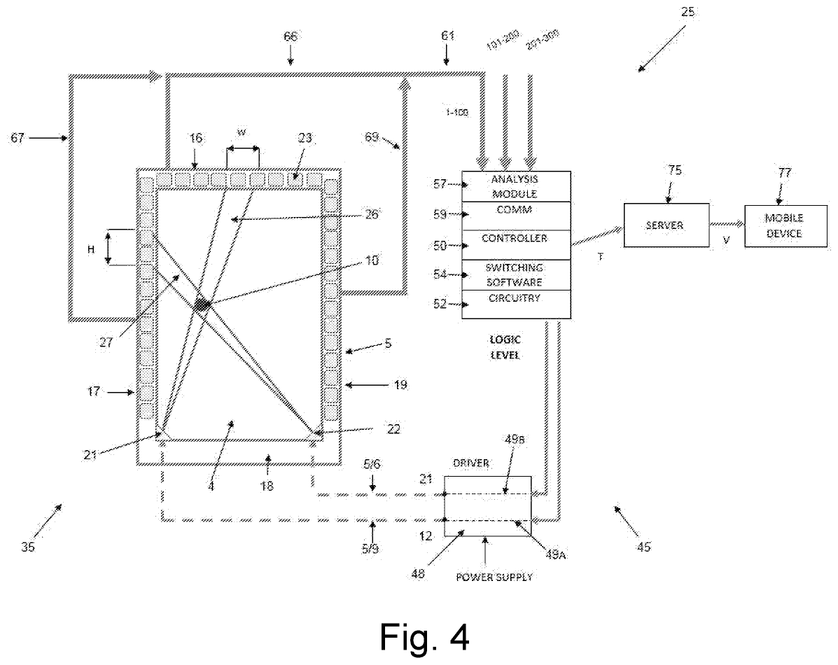

FIG. 4 schematically illustrates an embodiment of optical shooting accuracy indication system 25. System 25 comprises apparatus 35 for generating a single-layer optical screen and control apparatus 45 for distinguishing between light that is generated for the optical screen by two different light sources during two different time domains.

Optical screen generating apparatus 35 comprises rectangular frame 5 having an unobstructed interior 4 that is delimited by four frame sides 16-19. A first light source 21 facing frame interior 4 and generating wide-angle beam 26 is mounted at the corner of sides 17 and 18, and a second light source 22 facing frame interior 4 and generating wide-angle beam 27 is mounted at the corner of sides 18 and 19. A U-shaped array of light receivers 23 is deployed at three sides 16, 17 and 19 of the rectangular frame 5, such that each of the receivers 23 normally always receives the emitted light. The three sides of the U-shaped array may be connected to each other or integrally formed to produce a monolithic unit. Alternatively, the three sides of the U-shaped array may be separate from one another.

When a projectile 10 is fired through the frame interior 4, the projectile interrupts a portion of beams 26 and 27 and produces a shadowing effect whereby regions of the U-shaped array do not receive the emitted light due to the temporary interruption caused by the passage of projectile 10 through frame interior 4. A shadowed region W is produced at side 16 of the light receiver array by the interruption of beam 26, and a shadowed region H is produced at side 17 of the light receiver array by the interruption of beam 27.

The light produced by light sources 21 and 22 may be coherent or non-coherent light, pulsed or non-pulsed, and of any desired color. The light sources may be configured to produce a specific wide angle, or may be covered by a device such as a light guide to produce the specific wide angle.

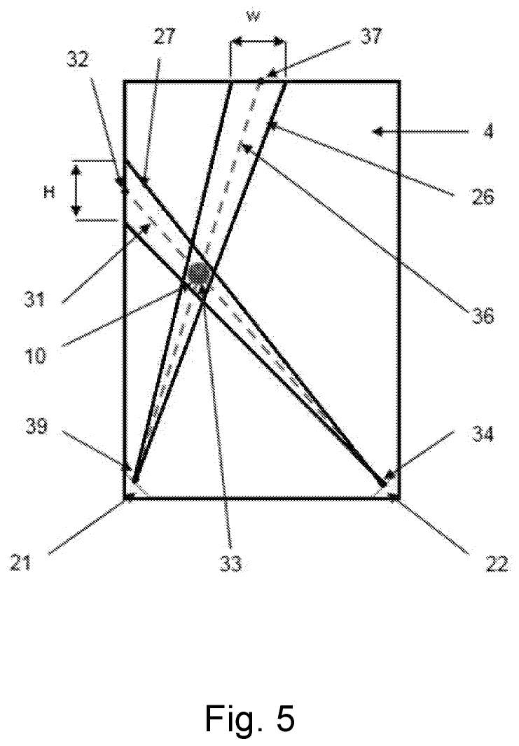

By knowing the location of shadowed regions H and W and of light sources 21 and 22, the location of the light sources being determined offline, the impingement region of projectile 10 with respect to frame interior 4 may be determined by the intersection of each line extended from the center of a shadowed region to the center of the corresponding light source. Thus as shown in FIG. 5, line 31 constituting the centerline of beam 27 is extended from the center 32 of shadowed region H to the center 34 of light source 22. Likewise, line 36 constituting the centerline of beam 26 is extended from the center 37 of shadowed region W to the center 39 of light source 21. The intersection of lines 31 and 36 at point 33 represents a region of frame interior 4 that is certainly impinged by projectile 10.

Control apparatus 45, which may be embedded in one of the four frame sides 16-19 to provide a compact arrangement, comprises a two-channeled driver 48 configured to alternately switch the activation power supplied to each of light sources 21 and 22 in cyclical fashion. The supplied electrical power in conjunction with the light source is sufficient to generate a wide-angle beam that is able to simultaneously illuminate all of the receivers 23 of the U-shaped array.

Control circuitry 52 of a controller 50, in response to commands initiated by switching software module 54, provides a binary input to each of the channels 49a and 49b of driver 48. At any given instant, the binary input to each of the channels 49a and 49b is different, and is subsequently switched following the next predetermined time interval. The current associated with the activation power flows either through cable 51a or cable 51b. Cable 51a associated with channel 49a and cable 512b associated with channel 49b extend to light sources 21 and 22, respectively. Consequently, each of light sources 21 and 22 is alternately activated and deactivated by means of driver 48 during each subsequent time interval.

Controller 50 also comprises an analysis module 57 for analyzing data received from each of the light receivers 23 to determine the impingement region of projectile 10 with respect to frame interior 4. A data bus in data communication with each light receiver 23 installed in a corresponding side of frame 5 is also in data communication with analysis module 57. That is, buses 66, 67 and 69 connected to sides 16, 17 and 19, respectively, provide an address for each light receiver installed in the corresponding side of frame 5, the physical distance on the frame between the given receiver and an adjacent receiver, and a discrete data indicator as to whether the given receiver is presently receiving light generated by one of the light sources or is subjected to a shadowing effect. The three buses 66, 67 and 69 may be connected to a common bus 61 that extends to analysis module 57, or, alternatively, extend directly to analysis module 57.

Analysis module 57 determines the impingement region of a fired projectile using preprogrammed instructions. Communication apparatus 59 of controller 50 transmits a signal T provided with data indicative of the impingement region within the frame interior to server 75, or to any other computerized device. If desired by a user, server 75 subsequently transmits a signal V provided with data indicative of the impingement region within the frame interior to a mobile device 77 held by the user, which displays user beneficial information relating to the user's shooting accuracy.

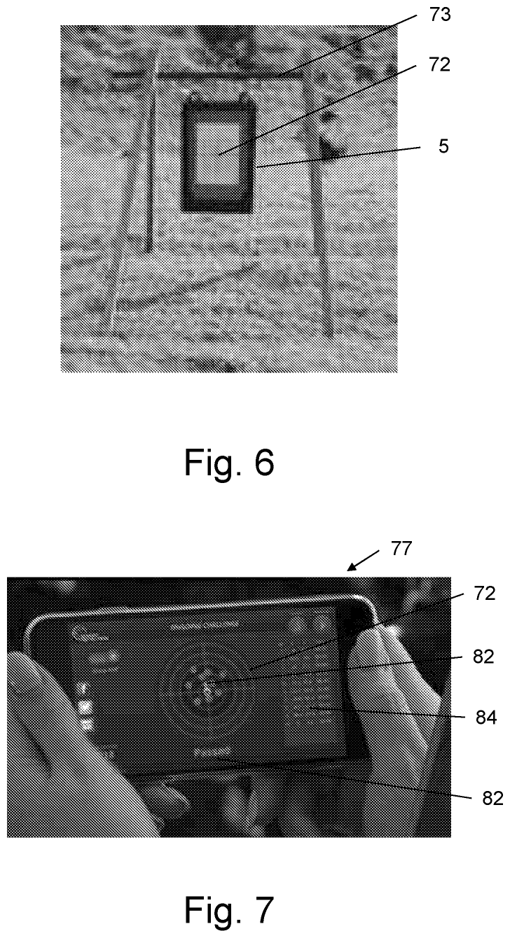

In operation, frame 5 is mounted, as shown in FIG. 6, in such a way that a target 72, which may be a physical target, is visible through its optical screen, preferably such that a central region of the optical screen coincides with the target. For example, frame is suspended from a horizontal support element 73. A calibration is made offline between a predetermined region of the optical screen and the target.

The analysis module normally receives a null data indicator via the data buses being indicative that each of the light receivers is exposed to non-interrupted light generated by one of the light sources at a given time. When a projectile is fired through the optical screen produced by a first light source, the light beam produced by the first light source is temporarily interrupted and a first shadowed region results at a frame side location that is dependent upon the relative impingement region of the projectile within the frame interior. The light receivers located at the first shadowed region each transmit a discrete, or a non-null, data indicator to the analysis module which is indicative that they are subjected to a shadowing effect. Likewise when the first light source is deactivated and the second light source is activated immediately thereafter, the light beam produced by the second light source is temporarily interrupted by the projectile before the latter passes through the thickness of the frame and a second shadowed region results at another frame side location that is dependent upon the relative impingement region of the projectile within the frame interior. The light receivers located at the second shadowed region then transmit a non-null data indicator to the analysis module.

After the analysis module receives the address of the light sources that were subjected to a shadowing effect, the center of the first and second shadowed regions is determined. A first line is generated that extends from the center of the first shadowed region to the center of the first light source. Similarly, when a second line is generated that extends from the center of the second shadowed region to the center of the second light source, the intersection of the first and second lines representing the impingement region of a longitudinal axis of the projectile within the frame interior is determined. The shooting deviation, or the derivative distance between the impingement region and the target, is then determined by the analysis module. Data indicative of the recently determined impingement region and shooting deviation is subsequently transmitted to the server for storage and further analysis.

Also, as shown in FIG. 7, handheld mobile device 77, by means of an application running on its processor and data received from the server, displays the impingement region 79 relative to the target 72 immediately after the shooting operation. If the shooting deviation is less than a predetermined threshold, a “PASSED” message 82 is displayed, otherwise a “FAILED” message is displayed. Thus the user receives immediate feedback as to his shooting operation without having to physically approach the target. The relative impingement regions generated following previous shooting operations may be displayed as well together with that of the most recent shooting operation. Statistical information 84, or user beneficial information relating to the user's shooting accuracy, may also be displayed. Such information 84 may include a deviation value and direction of deviation for the most recent shooting operation, an average user-specific shooting deviation, a day-specific shooting deviation for the user, and an average population-wide shooting deviation.

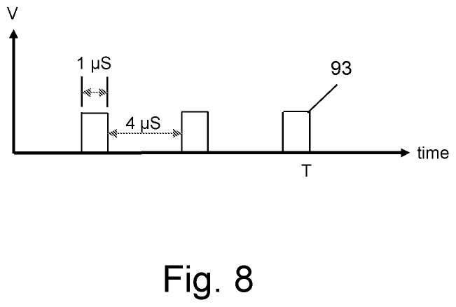

FIG. 8 illustrates a typical waveform 93 generated by the control circuitry for transmission to one channel of the driver. In order to switch the periodic binary input provided to the driver, the control circuitry cyclically generates an identical waveform to the other channel of the driver, but with a time shift between each input to the two channels that ensures that the two light sources will never be illuminated simultaneously. The control circuitry operates at a sufficiently high sampling rate such that the cycle time is less than the time taken by the fired projectile to cross the thickness of the U-shaped array of light receivers.

The generation of these two time shifted waves by the control circuitry advantageously facilitates the detection of a shadowed region produced by the interruption of the light source during a corresponding time domain by the fired projectile. With such a high sampling rate produced by the control circuitry having a greater frequency than the expected velocity of the projectile, which may be associated for example with a time shift of 0.5 μs for a pulse cycle of 1 μs when a projectile speed is up to 1000 m/s and the projectile length is at least 1 cm, the fired projectile is able to interrupt the light beam generated by both light sources and the analysis module is able to identify the two corresponding shadowed regions even when provided at an overlapped shadowed region.

Waveform 93 is shown to be characterized by periodic square waves, but it will be appreciated that other waveforms are also within the scope of the invention. The pulse width, which is generally less than 5 μs, is significantly less than the cycle time, for example 0.2 μs for a pulse cycle of 1 μs, and no more than a 25% duty cycle. The logic zero input may be represented by a voltage level of 0-0.03 V and the logic one input may be represented by a voltage level of 4.7-5.3 V.

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. An optical shooting accuracy indication system, comprising:
a) an apparatus for generating a single-layer optical screen with alternatingly switching first and second light sources; and
b) a control apparatus for distinguishing between light that is emitted by said first and second light sources during different first and second time domains, respectively, and for identifying an impingement region of a fired projectile through said generated optical screen.

2. The system according to claim 1, wherein the single-layer optical screen generating apparatus comprises:
i. a rectangular frame having an unobstructed interior that is delimited by four frame sides;
ii. the first light source which is mounted at a first corner of said frame and emits a beam of light that is directed to said frame interior;
iii. the second light source which is mounted at a second corner of said frame and emits a beam of light that is directed to said frame interior; and
iv. a single U-shaped array of light receivers which is deployed at three sides of said frame, such that all of said receivers are configured to simultaneously receive the light emitted by the first light source or by the second light source at any given time prior to impingement of a fired projectile through the generated optical screen,
wherein one or more regions of the light receivers are exposed to a shadowing effect due to a temporary interruption of a portion of the two beams emitted by the first and second light sources, respectively, caused by passage of the fired projectile through the frame interior.

3. The system according to claim 2, wherein the control apparatus comprises an analysis module, and a data bus in data communication with each of the light receivers which are installed at a corresponding side of the frame and with said analysis module, said data bus providing to said analysis module an address for each of the light receivers installed at the corresponding side of the frame and a discrete data indicator as to whether a given receiver is presently receiving light emitted by one of the first and second light sources or is subjected to a shadowing effect.

4. The system according to claim 3, wherein the analysis module is operable to receive and analyze a receiver-specific light-receiving data indicator from each of the light receivers and to determine the impingement region of the projectile with respect to the frame interior depending on which of the light receivers has been subjected to a shadowing effect.

5. The system according to claim 3, wherein the control apparatus further comprises a two-channeled driver configured to alternately and cyclically switch activation power supplied to each of the first and second light sources.

6. The system according to claim 5, wherein the control apparatus further comprises control circuitry responsive to a switching software module which is configured to generate a switching binary input to each of the two channels of the driver, such that the binary input to each of the two channels is different at any given instant.

7. The system according to claim 6, wherein the control circuitry cyclically generates an identical waveform to each of the two channels of the driver, but with a time shift between each input to the two channels that ensures that the first and second light sources will never be illuminated simultaneously.

8. The system according to claim 7, wherein the control circuitry operates at a sufficiently high sampling rate such that a cycle time is less than a time taken by the fired projectile to cross a thickness of the U-shaped array of light receivers.

9. The system according to claim 7, wherein a pulse width of the waveform is no more than a 25% duty cycle.

10. The system according to claim 2, wherein a physical target is visible through the optical screen.

11. The system according to claim 4, further comprising a communication apparatus in data communication with the analysis module and a computerized device in data communication with the communication apparatus, wherein the communication apparatus is operable to transmit to the computerized device a signal containing data which is representative of the determined impingement region of the projectile with respect to the frame interior.

12. The system according to claim 11, wherein the computerized device is a handheld mobile device which is configured with an application running on a processor of the mobile device, wherein the mobile device is operable to display the impingement region of the projectile relative to a target immediately after a shooting operation.

13. The system according to claim 12, wherein the mobile device is additionally operable to display user beneficial information relating to shooting accuracy of a user.
